(19) United States
(12) Patent Application Publication
(10) Pub. No.: US 2004/0069161 A1
(43) Pub. Date: Apr. 15, 2004

(54) Apparatus and method for sectioning fruit

(76) Inventors: Karyne Bazzano, Boston, MA (US); Raymond Bazzano, Boston, MA (US); James Knudsen, Cataula, GA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/448,733

(22) Filed: May 30, 2003

Related U.S. Application Data
(63) Continuation of application No. 10/262,594, filed on Sep. 30, 2002, now abandoned.
Application No. 10/262,594 is a continuation of application No. 10/072,609, filed on Feb. 7, 2002, now abandoned.

(51) Int. Cl. A23N 7/08

(52) U.S. Cl. 99/543; 99/545

(57) ABSTRACT

Aspects of the present invention are directed to methods and apparatus for sectioning produce into substantially equal pieces. A produce slicer is provided for sectioning the produce into substantially even wedges, the produce slicer includes a base unit for supporting a piece of produce and a slicing unit having an array of spaced apart blades for partitioning the piece of produce. The base unit further includes a plurality of individual support members that operate to force the piece of produce through the blade array and to guide the slicing unit during a slicing operation. The base unit and the slicing unit are designed to congruently mate, such that the blades of the blade array pass through the piece of produce and between the individual support members of the base unit.

### RELATED APPLICATIONS

This application is a continuation of U.S. Ser. No. 10/262,594, filed Sep. 30, 2002, which is a continuation of U.S. Ser. No. 10/072,609, filed Feb. 7, 2002, now abandoned, each of which is incorporated herein by reference.

### FIELD OF THE INVENTION

The present invention is directed generally to food processing devices and more specifically to devices for sectioning or subdividing food such as fruit into wedges.

### BACKGROUND OF THE INVENTION

Produce is often sliced or sectioned for a variety of applications. One such application is in the coring and sectioning of apples, pears and other fruit into edible pieces. Other applications are particularly relevant in the food industry, such as in the restaurant and bar industries, where it is often necessary to cut or slice fruit, particularly citrus, into individual wedged shapes for presentation to a customer as a garnish for food or beverages.

There are several types of prior art devices for slicing or sectioning produce. Many of these devices employ a stationary member and a movable member wherein one member will include sectioning means, such as an array of equally spaced blades, and the other member will include means for pushing the piece of produce through the sectioning means, such as an array of equally spaced members. As the two members are brought together the piece of produce is pushed through the sectioning means, thereby dividing the piece of produce into equally sized pieces.

In some designs, the stationary member will include sectioning means, while in other designs, the movable member will house the sectioning means. In many of the prior art designs, regardless of which member contains the sectioning means, the piece of fruit is rested on or in the stationary member while the movable member is brought together with the stationary member. In order to maintain proper alignment of the stationary and movable members during a slicing or wedging operation, many of these devices will employ a plurality of rod and sleeve alignment means for guiding the two members together. While generally adequate for alignment purposes, this method often requires pre-alignment of the rods and the sleeves prior to operation. It is desirable to provide a slicing apparatus wherein aligning one or more rods with a corresponding sleeve prior to slicing is not required.

Typical prior art sectioning devices also include an exposed or inadequately sheltered blade array, which often makes using them hazardous. Therefore, it is also desirable to provide a device that provides an improved enclosure for a blade array.

It is also desirable to provide a device that captures and contains any juice from the sliced fruit that may become dislodged during slicing, a device which has multiple surfaces for displaying advertisement and a device that is less expensive to manufacture than prior art designs.

### SUMMARY OF THE INVENTION

Embodiments of the present invention are directed to a produce slicer for sectioning produce into individual pieces. The produce slicer includes a base unit having a substantially cylindrical produce-supporting pedestal, wherein the pedestal has an exterior circumference, a slicing unit having a hollow cylindrical conduit, wherein the hollow cylindrical conduit includes an interior surface, an exterior surface, an upper end and a lower end, the hollow cylindrical conduit further having an inner circumference slightly larger than the exterior circumference of the cylindrical pedestal and a conical array of blades operatively disposed within the cylindrical conduit between the upper end and the lower end such that the conical array of blades is substantially sheltered from contact by an operator.

The interior surface of the hollow cylindrical conduit may slidably engage an exterior surface of the cylindrical produce-supporting pedestal thereby aligning and guiding the slicing unit during a slicing operation. The produce slicer can further include additional means for aligning the slicing unit during a slicing operation. The additional means for aligning the base unit with the slicing unit during a slicing operation may include a pair of curved guide members, wherein the curved guide members are arranged to slidably engage the exterior surface of the cylindrical conduit and wherein the curved guide members operate to channel the cylindrical conduit of the slicing unit over the produce-supporting pedestal of the base unit. Likewise, the additional means for aligning the base unit with the slicing unit during a slicing operation may include a pair of notches in the bottom end of the cylindrical conduit and a pair of corresponding tabs operatively located on the base unit such that the tabs slidably engage the notches and prevent the rotation of the slicing unit about a center axis during a slicing operation. The produce slicer may be dishwasher safe and it may include at least one substantially flat surface appropriate for advertising. Further, the conical array of blades may include a pin at a center of the conical array for piercing a piece of produce. In addition, the produce slicer may include a pair of handles operatively disposed along the exterior surface of the cylindrical conduit. The base unit may further include a basin for collecting an amount of juice run off.

Another aspect of the present invention is directed to a self-aligning produce slicer for sectioning a piece of produce. The produce slicer includes a slicing unit having a substantially cylindrical conduit, the conduit having an inner surface and an exterior surface, a conical array of blades operatively disposed within the cylindrical conduit, a base unit having a substantially cylindrical produce-supporting pedestal, the base unit further comprising a pair of curved guide members, wherein the curved guide members are arranged to slidably engage the exterior surface of the cylindrical conduit and the slicing unit further comprising a pair of handles, wherein each handle is operatively disposed about a portion of the exterior surface of the cylindrical conduit such that one of the curved guide members passes between the handles on either side of cylindrical conduit.

The slicing unit may include a pair of notches in the bottom end of the cylindrical conduit and the base unit may include a pair of corresponding tabs operatively located such that the tabs slidably engage the notches and prevent the rotation of the slicing unit about a center axis during a slicing operation.

Another aspect of the present invention is directed to a method for slicing produce with a produce slicer having a base unit that includes a substantially cylindrical support pedestal and a slicing unit having a substantially hollow cylindrical conduit with a conical blade array disposed therein. The method includes steps of placing a piece of produce on the produce-supporting pedestal of the base unit, aligning the hollow cylindrical conduit of the slicing unit with the cylindrical support pedestal and pushing the slicing unit against the piece of produce.

The method may also include the step of aligning an exterior surface of the hollow cylindrical conduit of the slicing unit between a pair of curved guide members.

### BRIEF DESCRIPTION OF THE DRAWINGS

For a better understanding of the present invention, reference is made to the drawings, which are incorporated herein by reference, and in which:

FIG. 1 is a perspective view of a fruit-sectioning device according to an embodiment of the present invention showing a base portion and a slicing portion;

FIG. 2 is a cross sectional view of a base portion of FIG. 1 and a part of a slicing unit including a blade array;

FIG. 3 is a top view of the base portion of FIG. 1;

FIG. 4 is an end view of the two portions of the fruit-sectioning device of FIG. 1 as mated;

FIG. 5 is a side view of the two portions of the fruit sectioning device of FIG. 1 as mated; and

FIG. 6 is a top view of the two portions of the fruit-sectioning device of FIG. 1 as mated.

### DETAILED DESCRIPTION

For purpose of illustration, the present invention will now be described with reference to slicing fruit, particularly lemons and limes. One skilled in the art, however, will appreciate that embodiments of the present invention are not limited to these particular fruits, and that the present invention may be used for other applications requiring the sectioning of produce, such as tomatoes, apples and the like.

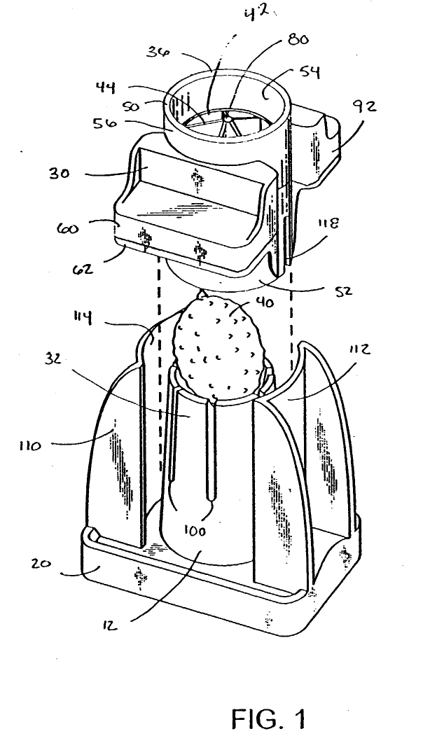

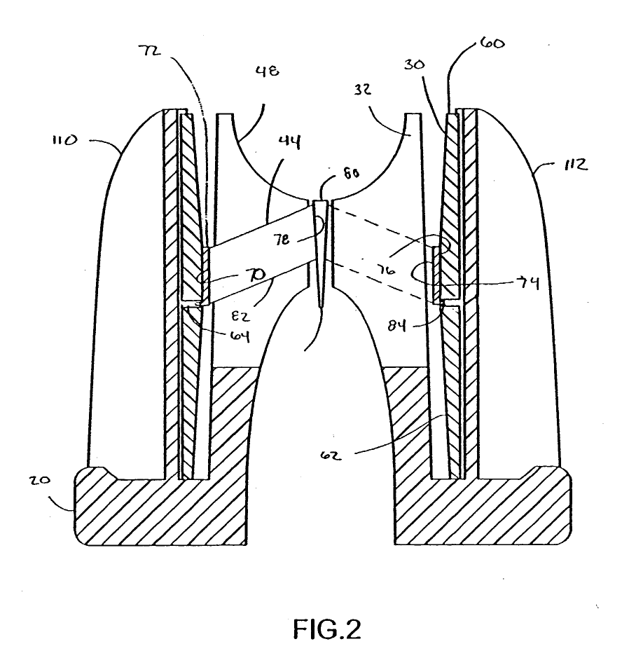

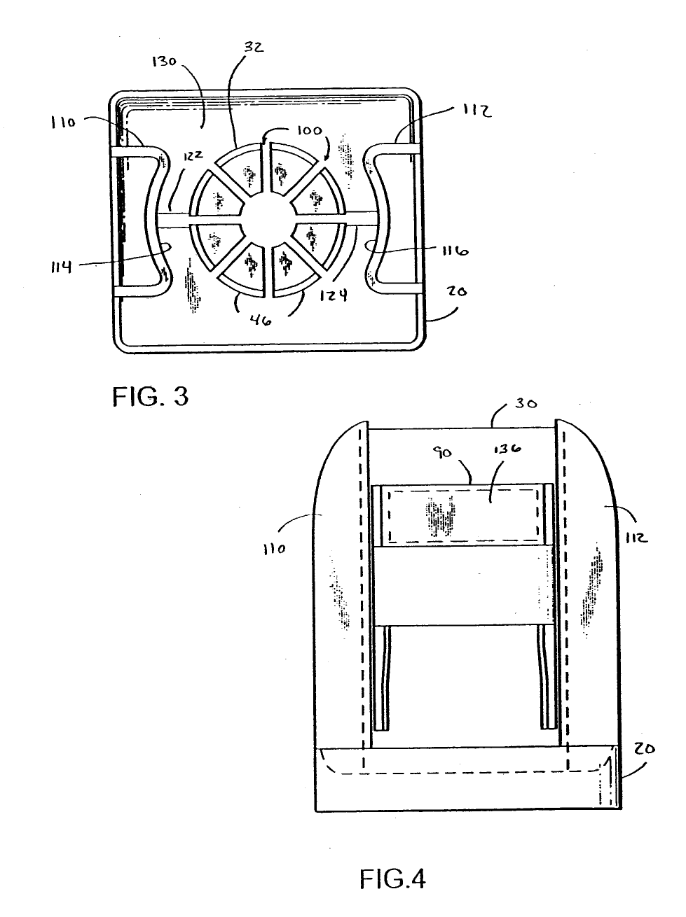

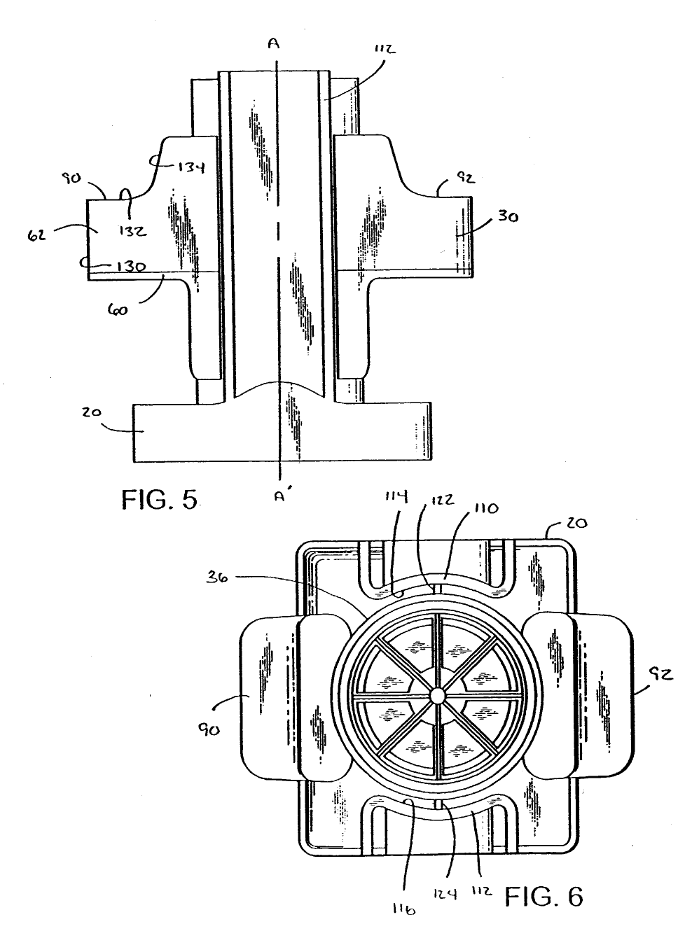

A first embodiment of a fruit-sectioning device 10 of the present invention will now be described with reference to FIGS. 1-6. The fruit-sectioning device 10 includes a base unit 20 and a slicing unit 30. In the present embodiment, the base unit 20 includes a generally cylindrical pedestal 12, however, it should be noted that several other pedestal shapes are contemplated, such as square, oval and the like.

Pedestal 12 includes a plurality of supporting members 32 for supporting a piece of fruit 40 during slicing. Each of the supporting members 32 has a curved exterior surface 46 and an inwardly curved upper surface 48. The supporting members 32 of the cylindrical pedestal 12 are arranged in a circular pattern wherein the plurality of curved upper surfaces 48 combine to form a bowl shaped surface upon which the piece of fruit 40 rests during slicing.

In the present embodiment, the slicing unit 30 includes a hollow cylindrical conduit 36, however, other conduit shapes are contemplated. The conduit 36 has a top end 50, a bottom end 52, an inner surface 54 and an exterior surface 56. In the present embodiment the slicing unit 30 is fashioned as a two-piece unit and includes a top piece 60 and a bottom piece 62 that are fastened together using screws (not shown), thereby forming a seam 64 at a point somewhat midway between the top end 50 and the bottom end 52 of cylindrical conduit 36. Other means for fastening the top piece 60 with the bottom piece 62, such as glue, rivets and the like are also contemplated. Additionally, the slicing unit 30 may be fashioned as a single piece unit.

The slicing unit 30 includes a conical blade array 42 that includes a plurality of equally spaced angled slicing blades 44. It should be noted that other blade array shapes may be employed, especially, if conduit 36 is not cylindrical. In the present embodiment, the angled slicing blades 44 are fabricated from a durable material, such as a commercial quality steel, which can withstand the acidity of the juice contained in citrus fruit and other produce, and that is capable of several slicing operations without the need for sharpening. The conical blade array 42 includes a ring 72, which has an inner surface 74 and an exterior surface 76. The slicing blades 44 are welded or otherwise attached on a first end 70 to the inner surface 74 of the ring 72. Each of the angled slicing blades 44 is welded or otherwise attached on a second end 78 to a fruit-piercing pin 80, thereby forming a conically shaped array 42. Each slicing blade 44 further comprises a downwardly facing, sharpened cutting edge 82. In certain other embodiments, the second ends 78 of the slicing blades 44 are connected together without a fruit-piercing pin 80.

The ring 72 also includes a circumferential lip 84 that protrudes away from the center of the blade array and that is substantially perpendicular to the inner surface 74 and the exterior surface 76 of the ring 72. In the present embodiment, the conical blade array 42 is positioned within the hollow cylindrical conduit 36. The exterior diameter of ring 72 corresponds with the inner diameter of cylindrical conduit 36 such that when the conical blade array 42 is inserted into hollow cylindrical conduit 36 the exterior surface 76 of ring 72 is flush with the inner surface 54 of the hollow cylindrical conduit 36.

To secure the conical blade array in place within the hollow cylindrical conduit 36, the circumferential lip 84 of the ring 72 is sandwiched between the top piece 60 and the bottom piece 62 of the slicing unit 30 within the seam 64. Securing the conical blade array 42 in this manner allows it to be easily removed and sharpened, repaired or replaced if one or more of the slicing blades 44 should become dull or damaged. It should be noted, however, that several other techniques are contemplated for attaching the conical blade array 42 within the cylindrical conduit 36, including screws, rivets, adhesive or other attachment means. In the present embodiment, the conical blade assembly 42 is remotely located from the bottom end 52 of cylindrical conduit 36, to prevent harm to an operator from accidental contact with the cutting edges 82 of the slicing blades 44.

As described above, the base unit 20 includes a plurality of supporting members 32 for supporting a piece of fruit 40 during slicing. The base unit 20 further includes a plurality of notches 100, with each notch 100 formed by and located between adjacent supporting members 32. As shown in FIG. 6, each notch 100 is constructed and arranged to allow a corresponding slicing blade 44 from the blade array 42 to pass between adjacent supporting members 32. Further, in the present embodiment, the bottom of each notch 100 is angled outward to direct any juice that escapes from the sliced fruit 40 into a bowl-shaped basin 130 in the base unit 20 for collection.

In the present embodiment, the inner circumference of the hollow cylindrical conduit 36 is slightly larger than the exterior circumference of the cylindrical pedestal 12. Therefore, as the slicing unit 30 is brought together with the base unit 20, the cylindrical pedestal operates to slidably channel the two units together. In addition, the base unit 20 further includes curved guide members 110, 112, which act to guide the cylindrical conduit 36 and thereby guide the slicing unit 30 down over the piece of fruit 40 and over the pedestal 12 onto the base unit 20. The curved guide members 110, 112, as shown, include a pair of semicircular faces 114, 116, which correspond to the curved exterior surface 56 of the cylindrical conduit 36.

During a slicing operation, a piece of fruit 40 is place on the curved upper surfaces 48 of the supporting members 32. The bottom end 52 of the cylindrical conduit 36 is placed over the piece of fruit 40. As the slicing unit 30 is brought down over the base unit 20 the slicing blades 44 pass through the piece of fruit 40 and into the notches 100, while the cylindrical conduit 36 passes over the exterior surface of cylindrical pedestal 12.

In addition to the guiding mechanisms described thus far for aligning the slicing unit 30 with the base unit 20 during the slicing of produce, the cylindrical conduit 36 further includes a pair of notches 118 that correspond to a pair of tabs 122, 124 at the bases of guide members 110, 112. As the slicing unit 30 engages the base unit 20, the tabs 122, 124 ride up into notches 118, thereby preventing the rotation of the slicing unit 30 about axis AA′.

For gripping, maneuvering and guiding the slicing unit 30 during a slicing operation, the slicing unit 30 also includes a pair of handles 90, 92, which are located on the exterior surface 56 of the cylindrical conduit 36. In the present embodiment, handles 90, 92 include substantially flat surfaces, 132, 134 upon which advertisements may be placed, for example in a section 136. Other advertising surfaces and shapes are contemplated whereby the functionality of the fruit sectioning device 10 is not compromised. For example, guide members 110, 112 may be formed in the shape of bottles (not shown) or other restaurant industry related shapes for the promotion of certain products or brands.

In embodiments of the present invention, either the base unit 20 or the bottom end 52 of the cylindrical conduit 26, or both, may include a rubber or some other resilient covering to absorb the shock of the end 52 contacting the base unit when cutting a piece of fruit.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A produce slicer for sectioning produce into individual pieces, the produce slicer comprising:
a base unit having a produce-supporting pedestal;
a slicing unit having a conduit, wherein the conduit includes an upper end and a lower end; and
a blade array operatively disposed within the conduit between the upper end and the lower end such that the blade array is substantially sheltered from contact by an operator.

2. The produce slicer of claim 1, wherein the conduit congruently mates with the produce-supporting pedestal.

3. The produce slicer of claim 2, wherein the conduit has an interior surface that slidably engages an exterior surface of the produce-supporting pedestal.

4. The produce slicer of claim 3, wherein the conduit is substantially cylindrical and wherein the produce-supporting pedestal is substantially cylindrical.

5. The produce slicer of claim 2, further comprising means for aligning the slicing unit during a slicing operation.

6. The produce slicer of claim 5, wherein the means for aligning the base unit with the slicing unit includes at least one guide member, wherein the at least one guide members is arranged to slidably engage an exterior surface of the conduit.

7. The produce slicer of claim 5, wherein the means for aligning the base unit with the slicing unit includes at least one notch in the bottom end of the conduit and at least one corresponding tab operatively located on the base unit such that the at least one tab slidably engage the at least one notch, thereby limiting rotation of the slicing unit about a center axis during a slicing operation.

8. The produce slicer of claim 1, wherein the produce slicer includes at least one surface appropriate for advertising.

9. The produce slicer of claim 1, wherein the blade array is conical in shape.

10. The produce slicer of claim 1, wherein the blade array further includes a pin at a center of the blade array for piercing a piece of produce.

11. The produce slicer of claim 1, wherein the slicing unit includes at least one handle operatively disposed along an exterior surface of the conduit.

12. The produce slicer of claim 1, wherein the base unit further includes a basin for collecting an amount of juice run off.

13. A self-aligning produce slicer for sectioning a piece of produce, the produce slicer comprising:
a slicing unit having a substantially cylindrical conduit, the conduit having an inner surface and an exterior surface;
a conical array of blades operatively disposed within the cylindrical conduit;
a base unit having a substantially cylindrical produce-supporting pedestal, the base unit further comprising a pair of curved guide members, wherein the curved guide members are arranged to slidably engage the exterior surface of the cylindrical conduit; and
the slicing unit further comprising a pair of handles, wherein each handle is operatively disposed about a portion of the exterior surface of the cylindrical conduit such that one of the curved guide members passes between the handles on either side of cylindrical conduit.

14. The self-aligning produce slicer of claim 11, wherein the slicing unit further comprises a pair of notches in the bottom end of the cylindrical conduit and wherein the base unit further comprises a pair of corresponding tabs operatively located such that the tabs slidably engage the notches and prevent the rotation of the slicing unit about a center axis during a slicing operation.

15. A method for slicing produce with a produce slicer having a base unit that includes a substantially cylindrical support pedestal and a slicing unit having a substantially hollow cylindrical conduit with a conical blade array disposed therein, comprising the steps of:
placing a piece of produce on the produce-supporting pedestal of the base unit;
aligning the hollow cylindrical conduit of the slicing unit with the cylindrical support pedestal; and
pushing the slicing unit against the piece of produce.

16. The method for slicing produce of claim 13, further comprising the step of aligning an exterior surface of the hollow cylindrical conduit of the slicing unit between a pair of curved guide members.
